(19) United States
(12) Patent Application Publication
(10) Pub. No.: US 2013/0069027 A1
(43) Pub. Date: Mar. 21, 2013

(54) Safety Barrier

(71) Applicants: Ingo Zimmermann, Mt. Gravatt East (AU); Frank Zimmermann, Mt. Gravatt East (AU); Steven Zimmermann, Mt. Gravatt East (AU)

(72) Inventors: Ingo Zimmermann, Mt. Gravatt East (AU); Frank Zimmermann, Mt. Gravatt East (AU); Steven Zimmermann, Mt. Gravatt East (AU)

(21) Appl. No.: 13/636,846

(22) PCT Filed: Mar. 24, 2011
(86) PCT No.: PCT/AU11/00345

§ 371 Date: Dec. 3, 2012

(30) Foreign Application Priority Data
Mar. 26, 2010 (AU) 2010901299

(51) Int. Cl. E06B 11/02; E04H 17/16

(52) U.S. Cl. CPC E06B 11/02; E04H 17/16
USPC 256/24; 256/73

(57) ABSTRACT

A gating system (100) for use in the construction of a temporary fence line is discussed. The gating system (100) includes a pair of frames (101,102). Frame (101) is hinged on its lateral end (101) d to an adjacent fencing panel (105) while frame (102) is hinged on its lateral end (102) d to an adjacent fencing panel (105) allowing the frames to be manoeuvred between an open and close position. In the closed position the first and second frame assemblies are brought into communication via an interlocking mechanism. As the frame assemblies are moved to the open position the interlocking mechanism maintains a coupling between the first and second frame assemblies unit to a predetermined distance from the closed position.

### BACKGROUND OF THE INVENTION

1. Field of the Invention

The present invention relates to system and methods for the provision of safety barriers or barricades. In particular although not exclusively the present invention is directed the provision of a gate and interlocking mechanism therefore to permit selective opening of a section of the barrier.

2. Discussion of the Background Art

During the construction of high-rise buildings the edges of floor typically remain exposed while major structural work is carried out. To ensure worker safety, temporary fencing is erected along the exposed edges. Occasionally openings are required in the fencing to permit the installation of loading bays which allow materials to be brought onto the floor typically via a crane of lift.

In order to install the loading bay, workers are normally required to be attach to safety lines via a harness. Once connected to the safety line the workers can then proceed to unbolt and remove the desired section of fencing to permit the installation of the loading bay. The use of harness and safety lines can in itself pose a safety hazard e.g. entanglement of the line on exposed beams etc, entanglement of co-works in safety line. In addition to this the use of lines and harness can be relatively expensive as both the lines and harness must undergo regular safety inspections, any minor fault in the harness and/or line and it must be replaced.

Accordingly there is a need for a system whereby an opening can be made in the temporary fencing to permit the installation of such loading bays etc that does not require the installation of safety lines or harness while maintaining worker safety.

### SUMMARY OF THE INVENTION

### Disclosure of the Invention

Accordingly in one aspect of the present invention there is provided a gating assembly for use with temporary fencing, said assembly including:
a first frame assembly and a second frame assembly said first and second frame assemblies being movable between a closed and open position;
an interlocking mechanism, said interlocking mechanism being attached to said second frame assembly and in communication with the first frame assembly, wherein the interlocking mechanism maintains a coupling between the first and second frame assemblies to a predetermined distance from the closed position as the first and second frame assemblies are moved between the closed and open position.

Preferably the first and second frame assemblies are brought into overlapping relation when in the closed position. Suitably the first and second frame assemblies are constructed from least two lateral and at least longitudinal members. Preferably least two lateral and at least longitudinal members are constructed from 50 mm Rectangled Hollow Section (RHS) steel

The first and second frame assemblies may be hinged at one end to an adjacent panel of the temporary fencing. The first and second frame assembly may each include a stanchion having a foot including a plurality of apertures for fixing the stanchion to a surface. Suitably the stanchion of the first frame assembly is detachable. In the case where the stanchion of the first frame assembly is detachable the stanchion includes two members for insertion into the longitudinal members of the first frame assembly. Suitably the two members of the stanchion are formed from 40 mm RHS for insertion into the ends of the 50 mm RHS of the longitudinal members of the first frame.

The interlocking mechanism may include a first plate pivotally attached to the second frame assembly. Preferably the interlocking mechanism is pivotally mounted to at least one of the longitudinal members of the second frame assembly via a support.

Suitably the interlocking mechanism is in communication with the first frame assembly via a first rail and a second rail extending from said plate thereby retaining the first frame assembly therebetween.

The interlocking mechanism may also include a second plate pivotally attached to the second frame assembly and spaced apart from said first plate, said rails extending between the first and second plates. Suitably the rails are a two part construction, wherein the rails include a solid core and an outer rolling sleeve.

Mesh may be attached to each frame assembly by means of a plurality of clips each clip extending over the mesh and a engaging a portion frame assembly. The clip may include an elongate arm extending downwardly from one edge of a bar, a return extending downwardly from bar and disposed on the opposing edge to that of elongate arm and a flange provided at the opposing end of return and extending upwardly from the opposing end of the return at an angle. Preferably the clip is positioned over at least one of the longitudinal members of the frame assemblies such that the flange grips the lower face of the longitudinal member. Suitably the elongate arm of the clip is woven through the mesh.

### BRIEF DETAILS OF THE DRAWINGS

In order that this invention may be more readily understood and put into practical effect, reference will now be made to the accompanying drawings, which illustrate preferred embodiments of the invention, and wherein:

FIG. 1A is a rear view of a gating system for use with temporary fencing according to one embodiment of the present invention;

FIG. 1B is a top view of the gating system of FIG. 1A;

FIG. 2A is a top view of an interlocking mechanism for use with the gating system of FIGS. 1A and 1B according to one embodiment of the invention;

FIG. 2B is a partial view of one of the arm assemblies for the interlocking mechanism of FIG. 2A;

FIG. 2C of an interlocking mechanism for use with the gating system according FIGS. 1A and 1B according to one embodiment of the invention

FIG. 3 is a schematic diagram illustrating the first stages of operation the gating system according to FIGS. 1A and 1B;

FIG. 4 is a schematic diagram illustrating the various stages of operation of the gating system according to FIGS. 1A and 1B;

FIG. 5 is a schematic diagram depicting a clip for use with the gating system according to one embodiment of the invention;

FIG. 6 is a schematic diagram depicting the clip of FIG. 5 installed on one of the lateral rails of the gating system according to one embodiment of the invention;

FIGS. 7A to 7C are a schematic diagram depicting the operation of one arrangement of a locking mechanism for securing a rail to the temporary fencing;

FIGS. 8A and 8B are a schematic diagram depicting a clip for use with a locking mechanism for securing a rail to the temporary fencing according to one embodiment of the invention;

FIG. 9 is a schematic diagram depicting a clip for use with a locking mechanism for securing a rail to the temporary fencing according to one embodiment of the invention;

FIG. 10A is a schematic diagram depicting the construction of a fencing panel of a temporary fencing system according to one embodiment;.

FIG. 10B is a schematic diagram depicting the construction of a use of a stanchion with the fencing panel of FIG. 10A;

FIG. 11 is a schematic diagram depicting a temporary fencing system modified to act as a full height material containment screen;

FIG. 12 is a detailed view of the interconnection between vertically adjacent portions of the material screen of FIG. 11;

FIG. 13 is a detailed view of the interconnection between the members of the material screen and supporting stanchion; and

FIG. 14 is a detailed view of a mounting bracket for securing a screening material to the material screen.

### DESCRIPTION OF EMBODIMENTS OF THE INVENTION

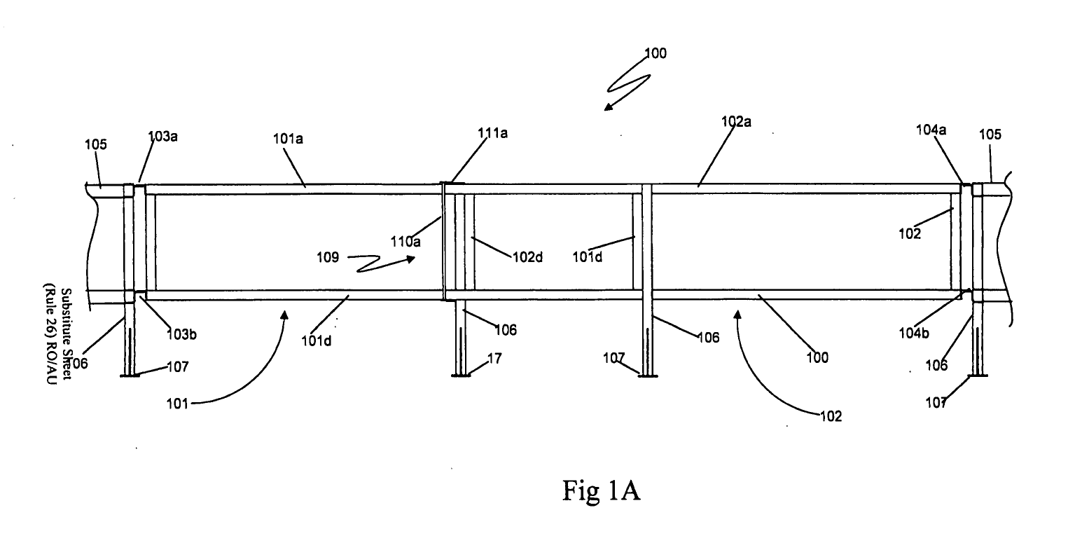

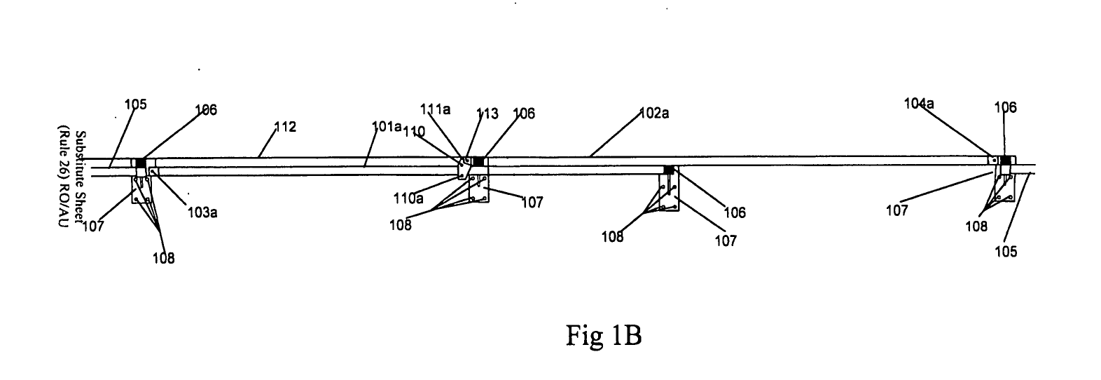

With reference to FIG. 1A there is illustrated a gating system 100 for use with temporary fencing according to one embodiment of the present invention. As shown the gating system 100 includes a pair of frames 101, 102. Each frame is composed of at least two longitudinal members 101a, 101b, 102a, 102b and at least two lateral members 101c, 101d, 102c, 102d. Frame 101 is hinged on its lateral end 101d to an adjacent fencing panel 105 via hinges 103a, 103b attached to the upper and lower longitudinal members 101a, 101b respectively. Likewise frame 102 is hinged on its lateral end 102d to an adjacent fencing panel 105 via hinges 104a, 104b attached to the upper and lower longitudinal members 102a, 102b respectively.

In the present example the gating system 100 is shown in the closed position with the sections of fencing 105 and the frames 101, 102 fixed in position by means of stanchions 106. Each stanchion 106 is fixed in place via the use of suitable anchoring mechanism inserted though a plurality of apertures 108 provided in the foot 107 of each of the stanchions 106 (see FIG. 1B). In the case of frames 101, 102 the stanchions 106 are attached to the free end of frames 101 and 102. An interlocking mechanism 109 is also mounted to frame 102 such that a portion of frame 101 is retained between the two lateral rails 110a, 110b of the interlocking mechanism 109.

FIG. 1B depicts a top view of the gating system of FIG. 1A. As shown frame 102 is mounted such that its outer edge aligns with the exposed edged 112. As shown the rear ends of stanchions 106 are also aligned along the exposed edge 112 with the exception of the stanchion attached to frame 101 which sits back from the edge 112 due to the overlap of a section of frame 101 with a portion of frame 102. In this particular example the interlocking mechanism includes an upper and lower plate 111a, 111b respectively With the rails 110a, 110b extending on opposing side of the frame 101 and between the two plates 111a, 111b. As shown plate 111a is mounted by a pivot to 113 to a support 114 extending from upper longitudinal member 102a.

It will of course be appreciated by those of skill in the art that while the gate of FIGS. 1A and 1B has be depicted in a right handed swinging configuration the gate can be readily be mounted as a left handed swinging configuration.

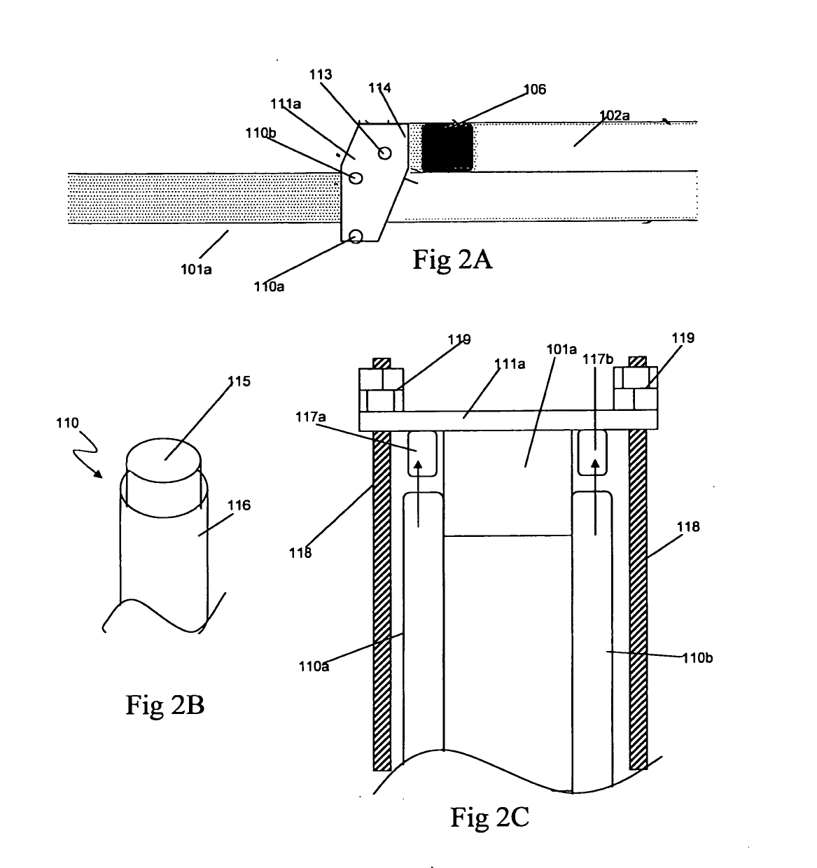

A more detailed view of the mounting arrangement for the interlocking mechanism is shown in FIG. 2A. As shown the longitudinal member 101a is positioned between rails 110a and 110b such that it abuts against the inner edge of longitudinal member 102a. Support 114 extends from longitudinal member 102a beyond the line of stanchion 106. Plate 111a is pivotally connected to the support 114 via pivot 113 and positioned substantially perpendicular to the frames 101, 102. As shown the pivot 113 is offset to rails 110a and 110b.

FIG. 2B depicts one possible arrangement for the construction of rails 110a, 110b. In this particular example the rails are constructed from a solid rod 115 with an out sleeve 116. In order to assemble the interlocking mechanism 109 the rods 115 forming the core of each rail 110a, 110b are secured to the base plate 111b via, for example, a spot weld to the outer sleeves 116 for each rail 110a, 110b are then slid over the respective cores 115 before the free end of the cores 115 are secured to plate 111a.

An alternate construction of the interlocking mechanism is shown in FIG. 2C in this instance the rails 110a, 110b are retained between plates by the use of a set of trunnions 117a, 117b extending from the plates 111a, 111b. As shown the trunnions are secured to and extend orthogonal to the surface of the plate with rails 110a, 110b then being pushed over their respective trunnions 117a, 117b. Thus in this particular construction the rails could be a solid rod with a blind bore provided in the end of each to accept trunnions 117a, 117b or they may be a tubular construction. In order to complete the construction a retaining strap or bracing 118 extending over the plates 111a, 111b to thereby maintain frictional engagement between the trunnions 117a, 117b and the rails 110a, 110b. In the depicted example the bracing is formed from a pair of threaded rods 118 extending through the plate and held in place via a locking nut arrangement 119. Accordingly this particular construction allows the interlocking mechanism to be disassembled for transport and storage.

It will of course be appreciated by a person of skill in the art that other arrangements for the mounting of the rails 110a, 110b in relation to the plates 111a, 111b are possible. For example the outer rail 110b need not fully span the distance between the upper 111a and lower 111b plate it could simply be a single projection from either plate provide that it retains a portion of the frame 101 between it and the outer rail 110a. It will also be appreciated by a person of skill in the art that while the above examples have been discussed in terms of a two rail gate/fence panel any number of rails could be utilised e.g. 3 rails 4 rails etc.

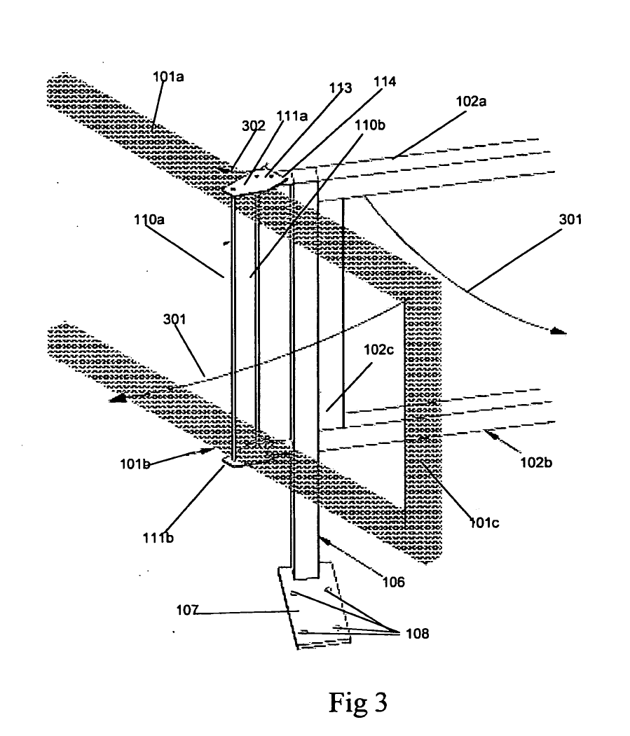

With regard to FIG. 3 there is depicted the initial stage of opening the gating system according to one embodiment of the invention. As shown as the frames 101, 102 are drawn inwardly in the direction of arrows 301. This causes plates 111a, 111b pivot outwardly on supports 114a, 114b about pivots 113 from a substantially perpendicular position toward a substantially parallel position to the upper 102a and lower 102b longitudinal members of frame 102 in the direction of arrows 302. As plates 111a, 111b pivot sleeves 116 of rails 110a, 110b engage the upper and lower longitudinal members 101a, 101b of frame 101. As the frames 101, 102 are drawn inwardly the sleeves 116 of rails 110a, 110b roll along the faces of the longitudinal members 101a, 101b and toward the lateral member 101c of frame 101.

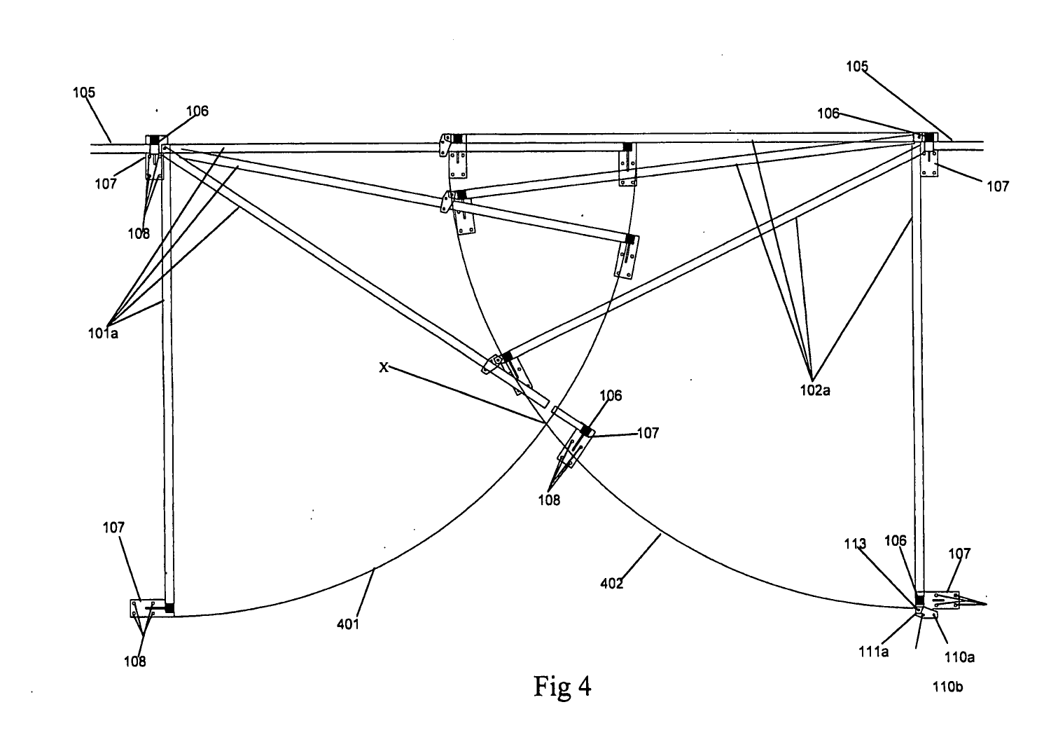

The opening operation of the gating system can be better appreciated by reference to FIG. 4. As discussed above when the frames are in the closed position a portion of frame 101 overlaps with a section of frame 102 such that the plate(s) 111a, 111b of the locking mechanism are positioned substantially perpendicular to the frames 101, 102. To facilitate the opening of the gating system the fixings holding stanchions 106 mounted on the lateral ends 101c, 102c of the frames 101, 102 in place are removed. Movement of the frames outwardly toward the exposed edge 112 is prohibited by the hinges 103a, 103b, 104a, 104b (i.e. hinges are mounted so as only to permit inward movement of frames 101, 102).

As frame 101 is drawn inwardly along arcuate path 401 plates 111a, 111b pivot outwardly toward the exposed edge 112 causing rails 110a, 110b to engage and travel along longitudinal member 101a, 101b toward the lateral end 101c. This action inturn draws in frame 102 along arcuate path 402. As frame 101 progress along path 401 locking mechanism 109 via the interaction of the rails 110a, 110b with the longitudinal members 101a, 101b continues to travel along the frame 101, causing frame 102 to follow behind frame 101 alone path 402. As frame 101 nears the apex of its arcuate path 401 the stanchion 106 is removed from the end of the frame 101 to allow the locking mechanism 109 to swing clear of frame 101 thereby releasing the connection between the frames 101, 102 at point X which is approximately 1.8 m to 2 m from the exposed edge.

Once the frames 101, 102 are detached from one another they are drawn through to the fully open position namely both frames 101 and 102 are positioned substantially perpendicular to the adjacent fencing panels to which they are hinged. Once in the fully open position stanchion 106 repositioned on frame 101 and secured in position by the insertion of suitable fasteners into the apertures 108 in the foot 107. Similarly frame 102 is secured in position by the insertion of suitable fasteners into the apertures 108 in the foot 107 of stanchion 106.

The fixing of the frames in this manner creates a partially fenced area for the insertion of a loading bay. Workers are then free to guide the bay into position from behind the safety of the fenced section thereby obviating the need for safety harnesses and lines. To prevent inadvertent entry into the exposed area between the frames 101, 102 a safety chain or the like may be attached between lateral members 101c, 102c (shown in FIG. 4 in dashed outline).

In most typical applications of the fencing and gating system panels steel mesh panels are attached to the fence panels and frames 101, 102. The mesh is then secured the fence panel by means of tie wire or the like. This is somewhat undesirable as the tie wire poses a safety risk e.g. risk of spiking or being cut by exposed wire. To alleviate this potential safety risk the applicant has developed a novel fastening mechanism for the attachment of mesh panels to the longitudinal members of the fencing panels and frames 101, 102.

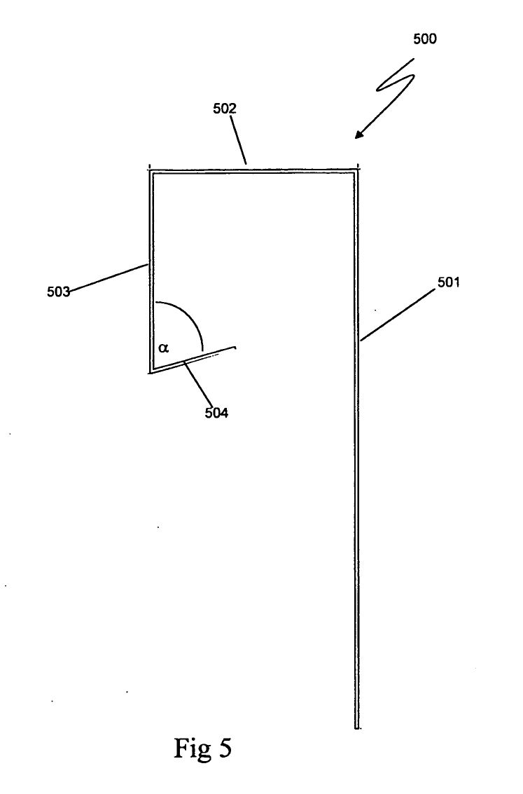

FIG. 5 depicts the basic construction of the novel fastening mechanism in the form of a clip 500 according to one embodiment of the present invention. As shown the clip 500 includes an elongate arm 501 extending downwardly from one edge of bar 502. The clip further includes a return 503 extending downwardly from bar 02 and disposed on the opposing edge to that of elongate arm 501. A flange 503 is provided at the opposing end of return 502. The flange 503 extending upwardly from the opposing end of the return 502 at an angle α.

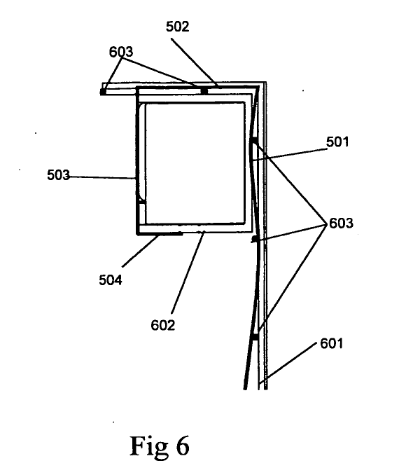

FIG. 6 shows the clip of FIG. 5 installed on one of the longitudinal rails of the gating system according to one embodiment of the invention. As shown the clip 500 is positioned over both the mesh 601 and the longitudinal rail 602 such that bar 502 retains at least one strand of the mesh 603 against the upper surface of the rail 602. The return 503 extends down along the outer vertical surface of the rail 602 thereby positioning flange 504 against the lower surface of the rail 602. The elongate arm 501 of the clip is woven through the strands of the mesh 603 such that a portion of the elongate arm is retained against the inner vertical edge of longitudinal member 602.

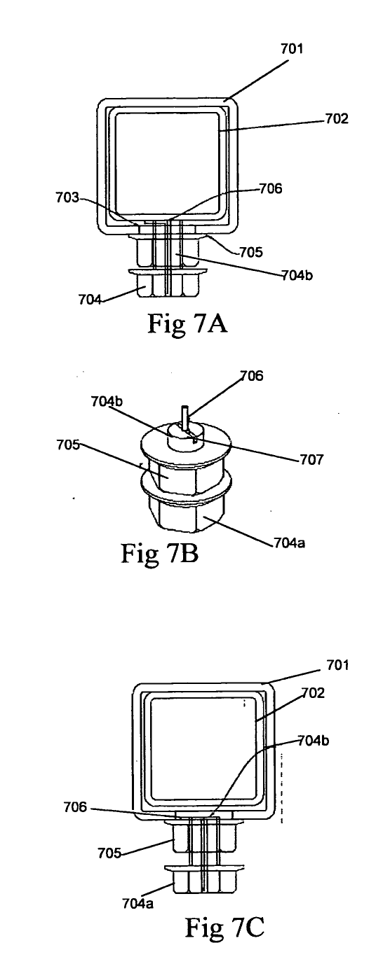

With reference to FIG. 7A there is shown one arrangement of a locking mechanism 700 for securing a section of a stanchion to a section of temporary fencing. In this instance the temporary fencing is made up of a plurality of 50 mm Rectangled Hollow Section (RHS) steel rails 701. The stanchions in this instance include at least two members formed from 40 mm RHS 702 for insertion into the 50 mm RHS 701 sections of the fencing panel. An aperture 703 is provided in the lower face of the 50 mm rail 701 to permit the insertion of bolt 704 for engagement with the 40 mm RHS member 702 to thereby lock the 40 mm RHS member 702 in place. The bolt 704 in this is retained in place by the use of a flange nut 705 which is positioned over the aperture and secured to the external surface of the lower face of the 50 mm rail 701.

The bolt 704 as shown in FIG. 7A is in the locked position such that the shaft 704b of the bolt 704 passes through flange nut 705 such that end of the shaft 704b is forced into engagement the lower surface of the 40 mm RHS member 702. The engagement of the end of the shaft 704b with the lower face of the 40 mm RHS member 702 forces lower face of the 40 mm RHS member 702 upward toward the inner surface of the upper face of the 50 mm rail 701. When the head 704a of bolt is brought into engagement with the flange nut 705 the upper face of the 40 mm member 702 is brought into engagement with the lower surface of the upper face of the 50 mm rail 702.

FIG. 7B shows the construction of the bolt 704 in greater detail, here the head 704a is engaged against the flange nut 705 such that the end of the shaft 704b extends beyond the lower surface of the flange nut 705. The shaft of the bolt 704b in this instance includes a blind bore into which a pin 706 is inserted and secured therein such that a portion of the pin extends proud of the end of the shaft 704b. The end of the shaft in this particular example includes a groove 707 for to allow the pin to fold inside as the end of the shaft 704b is engaged with the lower face of the 40 mm RHS member 702.

As the end of the shaft 704b engages the 40 mm member 702 the pin folds downwardly into the groove 707 such that the end of the pin extends orthogonal the shaft 704b when the bolt 704 is in the locked position (see FIG. 7A). When the bolt is released form the lock position to enable the removal of the 40 mm RHS member 702 per FIG. 7C the portion of the pin extended orthogonal to the shaft 704b abuts the lower face of the flange nut 705 preventing the complete removal of the bolt 704.

It will of course be appreciated by those of skill in the art that pin 706 need not be retained in a blind bore but could for example be a split pin which has one arm passing through an aperture in the shaft 704b of the bolt 704 with one arm of the pin engaging the head of the bolt 704a to secure the pin to the bolt.

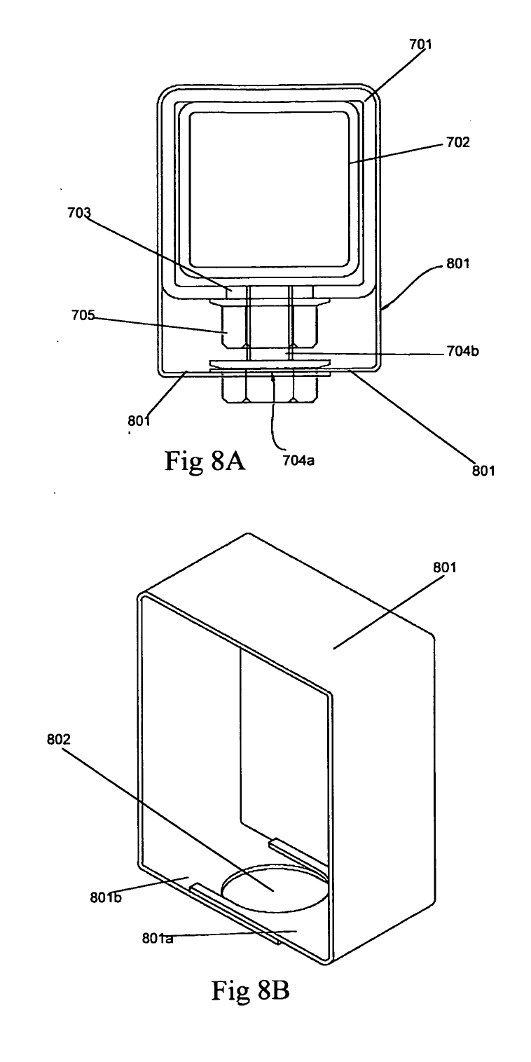

In the case of FIG. 8A the pin 706 of FIG. 7B has been replaced by a clip 801 which is designed to prevent the complete removal of the bolt from the 50 mm rail 701. As shown the shaft 704b of the bolt 704 passes through flange nut 705 such that end of the shaft 704b is forced into engagement the lower surface of the 40 mm RHS member 702 with the head 704a of bolt in engagement with the flange nut 705 (i.e. bolt in lock position). Clip 801 extends over the 50 mm rail 701 such that overlapping arms 801a, 801b are retained on the head 704a of the bolt.

FIG. 8B depicts the clip 801 in greater detail, as shown an aperture 802 for receiving the head 704a of the bolt 704 is formed in the base section of the clip formed by the overlapping arms 801a, 801b. As the clip is made form spring steel the overlapping arms are free to slide over one another with the application and release of tension on the vertical sides of the clip 801. Thus by the application of such tension the clip can be engaged and disengaged from the head of the bolt.

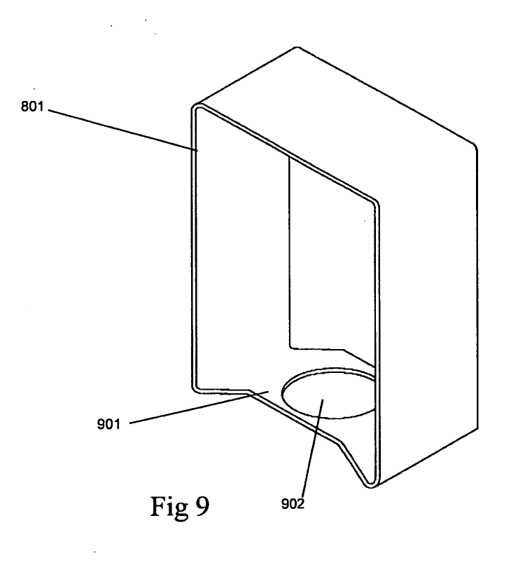

FIG. 9 depicts an alternate arrangement of the clip of FIGS. 8A and 8B. In this example the clip 801 includes a ridge 901 formed in the based of the clip. The ridge 901 is provided with an aperture 902 for receipt of the head 704a of the bolt 704. The clip is installed over the end of the 50 mm rail 702 prior to the insertion of the bolt 704 into the clip the flange nut 705. As the clip is made of spring steel the ridge 901 may be flexed downwardly to permit insertion of the bolt 704 into the flanged nut 705. Once the bolt 704 is retained within the flanged nut 705 the pressure on ridge 901 may then be released. This causes the ridge 901 to spring back to its original position forcing aperture 902 over the head 704a of the bolt 704 to prevent full removal of the bolt when in the non-locked position.

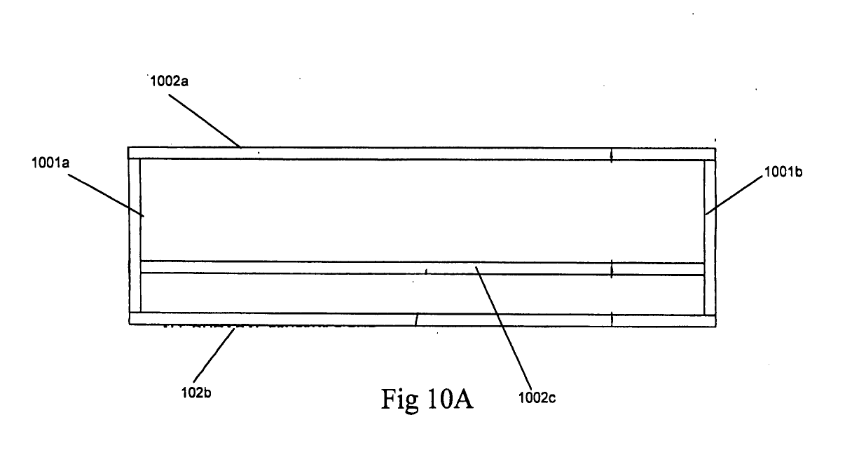

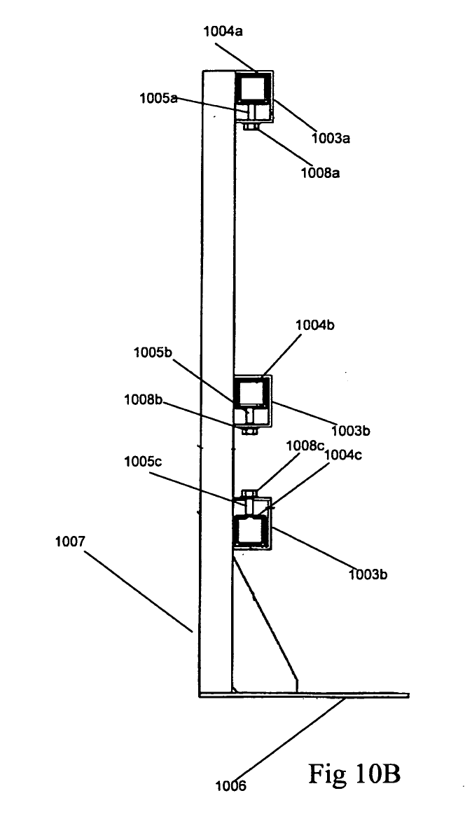

FIG. 10A depicts the construction of a temporary fencing panel 1000 for use in the construction of the gate assembly of the present invention. As shown the panel includes a frame composed of two lateral members 1001a, 1001b. A plurality of longitudinal members are disposed between the lateral members 1001a, 1001b in the depicted example three longitudinal members 1002a, 1002b and 1002c are utilised. Longitudinal members 1002a, 1002b in this case are disposed at opposing ends of the lateral members 1001a, 1001b while longitudinal member 1002c is retained within the frame formed by the combination of lateral members 1001a, 1001b and lateral members 1001a, 1001b. Longitudinal member 1002c in this instance is disposed at a distance of around 272 mm outside edge to outside edge from longitudinal member 1002b.

FIG. 10B depicts one possible construction of stanchion for use in a fencing system utilising the gate assembly of FIG. 10A. In this instance include at three members formed from fabricated C channel 1003a, 1003b, 1003c for insertion of 40 mm and 50 mm RHS sections of the fence rail 1004a, 1004b, 1004c. An aperture is provided in at least one of the faces of each fabricated C shaped rail support 1003a, 1003b, 1003c to permit the insertion of bolts 1005a, 1005b, 1005c for engagement with the 40 mm or 50 mm RHS rails 1004a, 1004b, 1004c to thereby lock the 40 mm or 50 mm RHS members 1004a, 1004b, 1004c in place. The bolts 1005a, 1005b, 1005c in this case are retained in place by the use of flange nuts which are positioned over the aperture and secured to the external surface of the C shaped rail support 1003a, 1003b, 1003c.

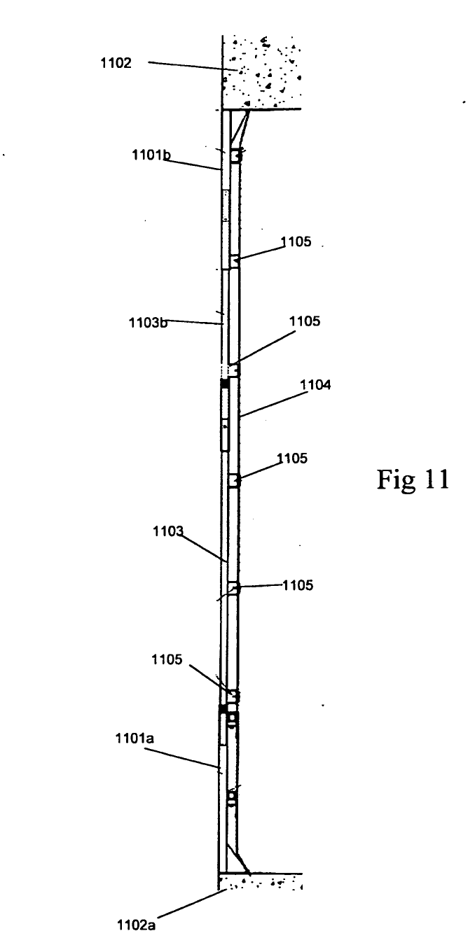

With reference to FIG. 11 there is illustrated a full hight (i.e. floor to ceiling) material screen 1100 which can be constructed by minor modification of the stanchions of the fencing system of the present invention. As shown stanchions 1101a and 1101b to the floor 1102a and ceiling 1102b respectively, a series of interconnected mullions 1103a, 1103b are then positioned within the void between the stanchions 1101a and 1101b. As shown the mullion 1103a has one end secured to stanchions 1101a while the opposing end is secured to one end of mullion 1103b which is in turn secured to the ceiling stanchion 1101b. Mesh 1104 is then fixed to a series of anchorage brackets 1105 disposed along the mullions 1103a, 1103b such that the mesh 1104 is position inside the building thereby preventing the escape of waste materials accumulated during the construction process.

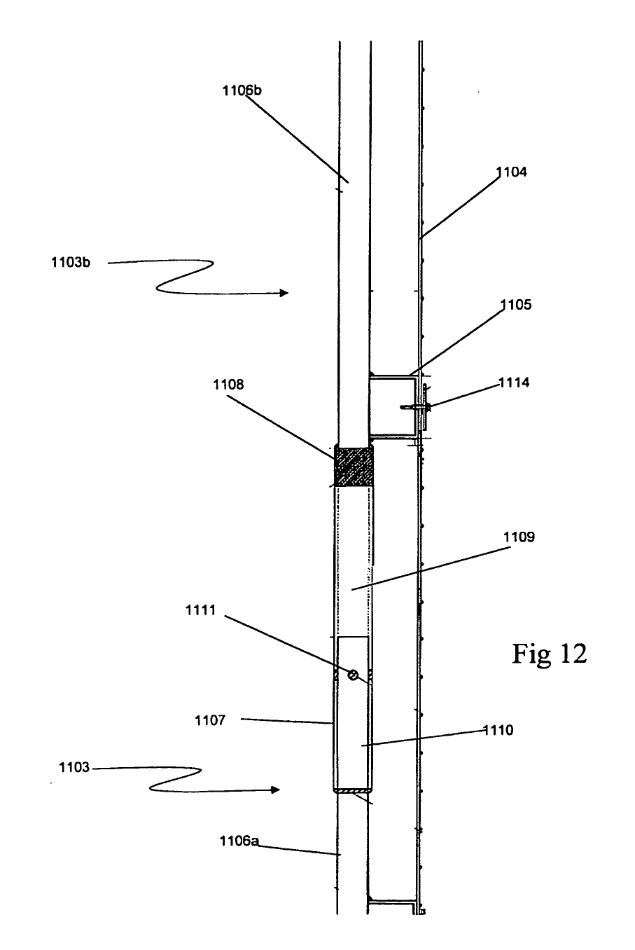

FIG. 12 shows the interconnection between the mullions 1103a, 1103b, in this case the mullions are constructed from 40 mm RHS members 1105a, 1105b which are interconnected a socket 1107 secured to the upper end of mullion 1103a. Socket 1107 in this instance is constructed from 50 mm RHS which enables a portion 1109 of the lower end of mullion 1103b to be telescopically inserted a minimum length of 200 mm. The socket 1107 is full welded to the lower mullion 1103a in the depicted example the socket 1107 such that the portion 1110 of the lower mullion retained therein in has a minimum length of 200 mm includes an aperture 1111 disposed centrally on all 4 of its faces which can then be plug welded. As can be seen in this example a stopper 1108 has been fitted to the upper mullion 1103b to prevent insertion of the lower end of the mullion 1103b past a desired depth.

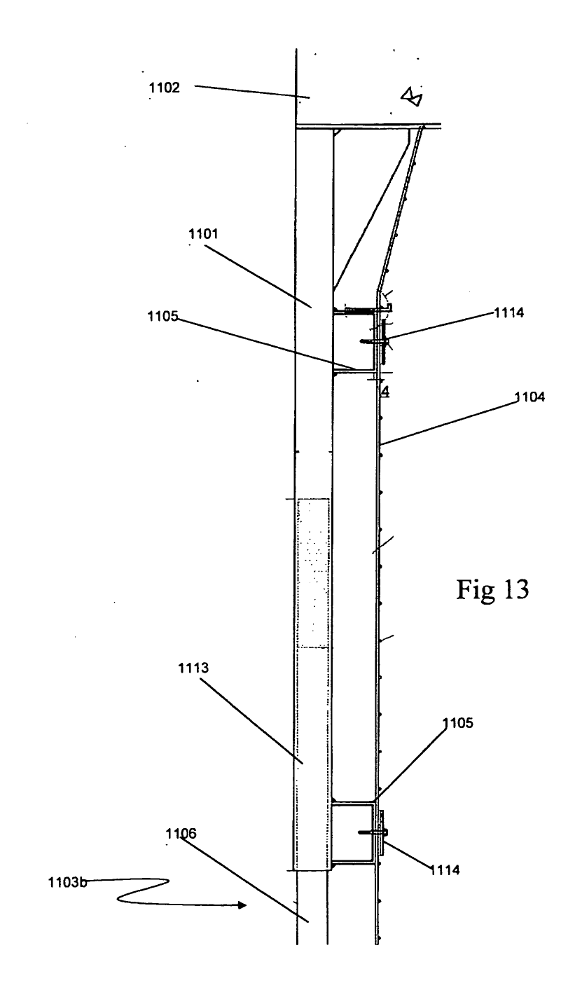

The interconnection of the mullions 1103a, 1103b with stanchions 1101a, 1101b is shown in FIG. 13. In this particular example the interconnection between the mullion 1103b and stanchion 1101b is shown. The stanchions utilised in the present invention are typically constructed from 50 mm RHS this allows for the upper end of mullion 1103b to be inserted telescopically into the hollow within stanchion 1101b. As with the engagement between mullion 1103a, 1103b discussed above the minimum length of the portion 1113 retained within the stanchion 1101b is 200 mm. However in this case there is no stop provide which enables the mullion 1103b to be slid up and down the length of the stanchion 1101b. Indeed this sliding action assist with the construction of the screen in general. For instance when mullion 1103b is positioned in stanchion 1101b it is slid to its limit once mullion 1103a is in position mullion 1103b is allowed to slide back thereby engaging with socket 1107 and ensuing that the portions 1109 and 1113 retained within the socket 1107 and stanchion 1101b are at least 200 mm in length.

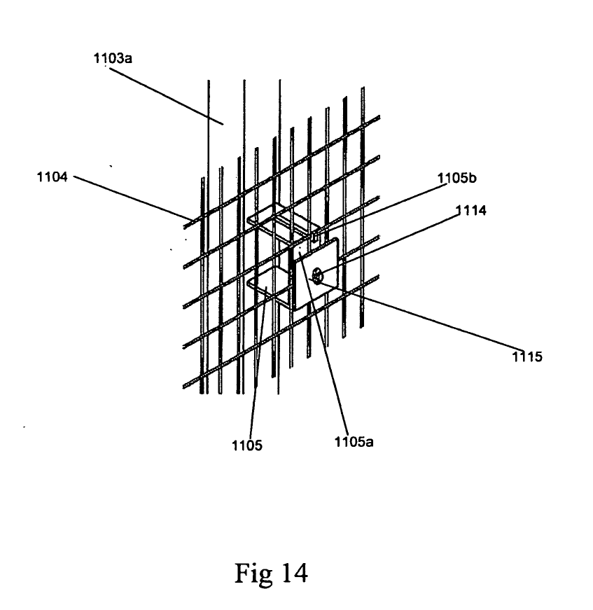

As can be seen form the examples depicted in FIGS. 12 and 13 the mesh 1104 is fixed to the anchorage brackets 1105 by a suitable fastener in this case the fastener is a screw 1114 which passed through the mesh 1104 and the anchorage brackets 1105. A more detailed view of the mounting arrangement for the mesh 1104 is shown in FIG. 14. As shown the mesh 1104 is held against the front face 1105a of the anchorage bracket 1105, in this particular example the bracket also includes a flange 1105b which engages one of the horizontal members of the mesh 1104. To secure the mesh in place a plate 1115 is placed on the side of the opposite side mesh 1104 which engages the front face 1105a of anchorage bracket 1105. The fastener 1114 is then inserted though the plate 1115 and into the anchorage bracket 1105 thereby clamping the mesh between the plate 1115 and front face 1105a of the anchorage bracket 1105.

It is to be understood that the above embodiments have been provided only by way of exemplification of this invention, and that further modifications and improvements thereto, as would be apparent to persons skilled in the relevant art, are deemed to fall within the broad scope and ambit of the present invention described herein.

1-33. (canceled)

34. A gating assembly for use with temporary fencing, said assembly including:
a first frame assembly and a second frame assembly said first and second frame assemblies being movable between a closed and open position;
an interlocking mechanism, said interlocking mechanism being attached to said second frame assembly and in communication with the first frame assembly, wherein the interlocking mechanism maintains a coupling between the first and second frame assemblies to a predetermined distance from the closed position as the first and second frame assemblies are drawn through an arcuate path between the closed and open position.

35. The gating assembly of claim 34 wherein the first and second frame assemblies are brought into overlapping relation when in the closed position.

36. The gating assembly of claim 34 wherein the interlocking mechanism includes a first plate pivotally attached to the second frame assembly.

37. The gating assembly of claim 36 wherein the interlocking mechanism is in communication with the first frame assembly via a first rail and a second rail extending from said plate thereby retaining the first frame assembly therebetween.

38. The gating assembly of claim 37 wherein the interlocking mechanism further includes a second plate pivotally attached to the second frame assembly and spaced apart from said first plate, said rails extending between the first and second plates

39. The gating assembly of claim 37 wherein the rails are a two part construction.

40. The gating assembly of claim 39 wherein the rails include a solid core and an outer rolling sleeve.

41. The gating assembly of claim 34 wherein the first and second frame assemblies include at least two lateral and at least two longitudinal members.

42. The gating assembly of claim 41 wherein the first and second frame assemblies are hinged at one end to an adjacent panel of the temporary fencing.

43. The gating assembly of claim 41 wherein the interlocking mechanism is pivotally mounted to at least one of the longitudinal members of the second frame assembly via a support.

44. The gating assembly of claim 34 wherein the first frame assembly further includes a stanchion having a foot including a plurality of apertures for fixing the stanchion to a surface said stanchion being detachable from said first frame assembly.

45. The gating assembly of claim 34 wherein the second frame assembly further includes a stanchion having a foot including a plurality of apertures for fixing the stanchion to a surface.

46. The gating assembly of claim 34 wherein mesh is attached to each frame assembly.

47. The gating assembly of claim 46 wherein the mesh is attached by means of a plurality of clips each clip extending over the mesh and engaging a portion of the frame assembly.

48. The gating assembly of claim 47 wherein a portion of the clip is woven through the mesh.

49. A method for the construction of a temporary fence line wherein said method comprises the use of the gating assembly of claim 34.

50. A temporary fencing system, said system including:
a plurality of fencing panels wherein the panels are interconnected by a series of support members positioned between each fencing panel thereby forming a fence line; and
a gating assembly disposed between a pair of support members within the series of support members said gate assembly including
a first frame assembly and a second frame assembly said first and second frame assemblies being movable between a closed and open position; and
an interlocking mechanism, said interlocking mechanism being attached to said second frame assembly and in communication with the first frame assembly, wherein the interlocking mechanism maintains a coupling between the first and second frame assemblies to a predetermined distance from the closed position as the first and second frame assemblies are drawn through an arcuate path between the closed and open position; and
wherein in the closed position the gating assembly maintains the continuity of the fence line.

51. The temporary fencing system of claim 50 wherein the first and second frame assemblies are brought into overlapping relation when in the closed position.

52. The temporary fencing system of claim 50 wherein the interlocking mechanism includes a first plate pivotally attached to the second frame assembly.

53. The temporary fencing system of claim 52 wherein the interlocking mechanism is in communication with the first frame assembly via a first rail and a second rail extending from said plate thereby retaining the first frame assembly therebetween.

54. The temporary fencing system of claim 53 wherein the interlocking mechanism further includes a second plate pivotally attached to the second frame assembly and spaced apart from said first plate, said rails extending between the first and second plates

55. The temporary fencing system of claim 53 wherein the rails are a two part construction.

56. The temporary fencing system of claim 55 wherein the rails include a solid core and an outer rolling sleeve.

57. The temporary fencing system of claim 50 wherein the first and second frame assemblies include at least two lateral and at least two longitudinal members.

58. The temporary fencing system of claim 57 wherein the first and second frame assemblies are hinged at one end to an adjacent panel of the temporary fencing.

59. The temporary fencing system of claim 57 wherein the interlocking mechanism is pivotally mounted to at least one of the longitudinal members of the second frame assembly via a support.

60. The temporary fencing system of claim 50 wherein the support members are in the form of stanchions, each stanchion including a foot having a plurality of apertures for fixing the stanchion to a surface.

61. The temporary fencing system of claim 60 wherein each stanchion includes a least two rail mounts and wherein the fence panels are formed by the insertion of one or more rails into the rail mounts.

62. The temporary fencing system of claim 61 wherein the rail mounts further include an interlocking mechanism for securing the rail within the rail mount.

63. The temporary fencing system of claim 50 wherein the first and second frame assemblies of the gating assembly each includes a stanchion having a foot including a plurality of apertures for fixing the stanchion to a surface.

64. The temporary fencing system of claim 50 wherein mesh is attached to fence panels and each frame assembly of the gate assembly.

65. The temporary fencing system of claim 50 wherein the mesh is attached by means of a plurality of clips each clip extending over the mesh and engaging a portion of the frame assembly and/or fence panel.

66. The temporary fencing system of claim 65 wherein a portion of the clip is woven through the mesh.
